(19) United States
(12) Patent Application Publication
(10) Pub. No.: US 2008/0012288 A1
(43) Pub. Date: Jan. 17, 2008

(54) Print Substrate with a Scrambling Pattern for Concealing a Confidential Information Sequence

(76) Inventor: Jules Fischer, Oberwil-Lieli (CH)

Correspondence Address: MORGAN LEWIS & BOCKIUS LLP, 1111 PENNSYLVANIA AVENUE NW, WASHINGTON, DC, 20004, US

(21) Appl. No.: 11/631,600

(22) PCT Filed: Jul. 7, 2005
(86) PCT No.: PCT/CH05/00388

§ 371 Date: May 31, 2007

(30) Foreign Application Priority Data
Jul. 7, 2004 (CH) 1142/04
Aug. 17, 2004 (CH) 1353/04
Oct. 28, 2004 (CH) 1783/04
Feb. 17, 2005 (CH) 282/05

(51) Int. Cl. B42D 15/00

(52) U.S. Cl. 283/94

(57) ABSTRACT

The invention relates to stock comprising a masking field on which an information pattern can be printed in such a way that it can be recognised in front of the background of the masking field only once certain manipulations have been carried out. The aim of the invention is to increase the security of the confidential information. To this end, the following measures are carried out individually or as a combination: the masking field contains irregularly distributed colour points of between 50 and 400 μm, amounting to an entire surface area of between 0.3 and 0.5 cm² per cm²; and/or the masking field consists of a plurality of superimposed printed layers; and/or the masking field is printed with a printing ink, of which at least 50% is concentrated in a masking field layer; and/or the masking field can be removed, at least partially and/or together with other layers, using an adhesive strip, with a peeling force of between 0.5 N/50 mm and 2 N/50 mm according to the Finat test method no. 1; and/or the stock is provided with a thermochromatic reagent which changes colour irreversibly under the effect of heat, from a temperature of 140°; and/or the stock is provided with a solvent-reactive reagent which changes colour irreversibly in a solvent atmosphere.

### TECHNICAL FIELD

The present invention relates to a print substrate with a scrambling pattern on which an information sequence made up of printed characters, for instance, can be printed using standard printing ink, particularly with today's conventional laser or inkjet printers, in such a manner that it can only be distinguished by the naked eye once certain actions have been performed. The term “standard printing ink” should also include, accordingly, the toner used by laser printers or the ink used by inkjet printers.

Print substrates of this nature are used for the mailing of bank or credit card PIN's, passwords or similarly sensitive information to their recipients, without unauthorised third parties having the implicit opportunity of gaining access to this information. Only the authorised recipient is able to distinguish the information with the naked eye by performing certain actions. The actions are of such a nature that they leave behind irreversible signs, making it evident if attempts have been made by unauthorised third parties at least to read the information with the naked eye. The term “tamper indication” is used in this context.

### BACKGROUND ART

A print substrate of the type mentioned is known from WO 99/24267 A1. Here, a transparent film is disposed on another substrate, such as a sheet of paper, for instance, where a scrambling pattern has been printed beforehand.

The confidential information is printed on the film's upper surface. With a suitable variant, this cannot be read, at least with the naked eye, against the background of the scrambling pattern, which is visible through the film. It is only readable once the film and the substrate have been separated, wherein this separation leaves behind irreversible signs necessary to indicate tampering.

In accordance with another embodiment known from EP 1 120 291 A2, the confidential information is made readable by the decolouration of a printing ink used in the scrambling pattern under the effects of heat. However, EP 1 120 291 A2 contains no further details of a printing ink suitable for this. It would seem debatable whether the clearly desired thermochromatic effect can be made sufficiently irreversible to provide clear evidence of tampering too.

By contrast, WO2004/106085 A1 suggests that in order to make the confidential information visible, the printing ink used for the scrambling pattern should be irreversibly decoloured using a chemical reagent.

With all print substrates known hitherto, the contrast of the confidential printing following removal of the scrambling pattern effect has been somewhat weak and in need of improvement.

In previously known embodiments, the scrambling pattern has been a sea of figures created by superimposing a wide variety of printed characters against a random dark background, in which the characters forming the confidential information sequence can no longer be distinguished by the naked eye and seemingly disappear against it. However, by using technical means it is still possible with the known embodiment to read the confidential information without this being evident subsequently.

EP 1 001 884 B1 discloses how this sort of scrambling can be improved by printing the areas forming the confidential information sequence with a coverage of under 100%, which can be achieved, for example, by means of rasterization by breaking down the characters into a plurality of small dots. In order to improve the scrambling of the characters printed in this way still further, EP 1 001 884 B1 also proposes the application of a raster of small dots to the scrambling pattern. Even if the individual dots were distinguishable using a microscope, for instance, there is the difficulty in this case of attributing them firstly to the confidential information and secondly to the scrambling pattern.

In relation to the aforementioned uses for conveying PIN's etc, it is usually sufficient in this case to guarantee security during printing at the print shop up to the stuffing of the envelopes, which is usually done automatically. Staff involved in printing should not be able to read the confidential information easily, particularly when it is printed along with the recipient's personal details in the same document. However, opportunities for tampering or using technical means are relatively limited at this stage and may be restricted still further by introducing suitable organisational measures at the print shop.

Recently, however, applications have also been considered in which the authorised recipient has, for particular reasons, not used and made readable the confidential information sent to him on the substrate and has also been able to verify this where necessary by presenting the substrate still intact. It goes without saying that in this case the recipient has far more time available to him, where necessary, and technical means could also be used to read the confidential information and then remove any signs of this, without this subsequently being immediately evident to a third party.

### DESCRIPTION OF THE INVENTION

The object of the present invention, bearing in mind, among other things, the applications just mentioned, is to continue improving the security of confidential information using a print substrate with a scrambling pattern of the type mentioned at the beginning.

This object is solved by at least one of the features indicated in patent claim 1. Preferred embodiments are given in the dependent claims.

The first of the solution features according to the invention involves the scrambling pattern containing randomly distributed ink dots with irregular diameters within the range 20-400 μm and a total surface area of between 0.3-0.5 cm² per cm².

With this feature, the scrambling improvement through rasterization of the confidential information and the addition of raster dots to the scrambling pattern already known from EP 1 001 884 B1 is significantly improved. It has emerged, namely, that the raster dots of the confidential information in EP 1 001 884 B1 can be distinguished simply on account of their geometric configuration from the likewise geometrically configured raster dots in the scrambling pattern, given sufficient magnification, e.g. under a microscope. However, this discrimination is made virtually impossible by an irregular configuration of ink dots with irregular diameters of the aforementioned variable type in the scrambling pattern and also with a greater density than that with which the raster dots of the confidential information are usually printed.

The density of the ink dots can be chosen so that the number of ink dots is in the region of 50-100 μm 2000-5000 per cm², in the region of 100-200 μm 500-1000 per cm² and in the region of 200-400 μm 200-500 per cm².

The scrambling pattern should preferably be printed using a liquid printing ink, in which case the ink dots are formed by particles added to the printing ink. This takes account of the fact that it is difficult or at least time-consuming and/or costly to print random dots with irregular diameters in the given size range and also in the given density.

In the context of the invention, a liquid printing ink such as that described in WO 2004/106085 can be used to print the scrambling pattern, which unlike standard printing ink, such as laser printer toner or inkjet printing ink, in particular, can be irreversibly bleached using a chemical decolouring agent.

The special printing ink may, for example, be produced through a reaction of CB and CF products, such as those used in carbon paper, which will be familiar to the person skilled in the art.

A suitable chemical decolouring agent in this case is a desensitisation printing ink for the CF product, such as that used in printing technology to remove the self-copying properties of chemical paper, and also, in particular, a solution containing ethoxylated amines. Bleaching agents are also suitable as chemical decolouration products, such as those used to bleach paper and textiles, including Javel water or the product DIRAXON S12 from CECA (F-920562 LA DEFENSE), CAS No. 61790-85-0.

The particles added to the printing ink to produce the ink dots in the scrambling pattern are preferably porous and have through the absorption of printing ink taken on a colour roughly matching this. Suitable particles are known from so-called matting agents and may consist of amorphous silicic acid, for instance. However, these particles only have a grain size of 5-7 μm. Ink dots with diameters in the desired size range of 50-400 μm are nevertheless produced through the agglomeration of these particles. Because not all particles used agglomerate to produce the desired ink dots in the specified size range, there is also a relatively large number of smaller ink dots, which contribute little, however, to the desired scrambling effect.

The use of smaller particles and the agglomeration of these, as compared with the use of larger particles with diameters right within the specified size range, has the advantage that the agglomerations tend to be flatter and therefore fit into the scrambling layer well, while larger particles would stand out from the scrambling layer, making them recognisable as such.

The second of the solution features according to the invention involves the scrambling pattern being made up of a plurality of superimposed printed layers.

As the thickness of the scrambling pattern layer increases, its so-called opacity value rises, as can be measured, for example, using a standard graphics industry densitometer. The colour intensity of the scrambling pattern is thereby increased and confidential information can be more effectively concealed in this way. Alternatively or additionally, the confidential information itself could also be more intensively printed, which would then improve its readability following removal of the scrambling field.

However, there are technical limits on the thickness of the scrambling pattern layer, due to the application amount, drying and unwanted proofs or the doubling of the printing in the batch or on the roll. By building up the scrambling pattern layer from a plurality of superimposed printed layers, a layer of sufficient thickness can thereby be achieved. The plurality of sublayers means that the appearance of the scrambling pattern can be further enhanced with an improved distribution of the particles producing the aforementioned ink dots.

In particular, the “white” areas in the scrambling pattern diminish, i.e. those areas that are not coated with printing ink when the scrambling pattern is produced in the form of a sea of numbers and on which there are no particles generating ink dots either.

Alternatively or additionally, the colour intensity of the scrambling pattern can also be further increased based on the third solution feature according to the invention by concentrating at least 50% of the printing ink used to print the scrambling pattern in a scrambling pattern layer. Preferably, at least 90% of the printing ink should be concentrated in the scrambling pattern layer.

This is not the case, for example, if standard, uncoated paper is used as the substrate for the scrambling pattern. This has the property of absorbing at least most of the printing ink, so that the print is quickly smudge-proof. The term also used for this in offset printing jargon is ink absorption, while this effect is particularly pronounced in paper with only a small amount of sizing, such as that preferably used in connection with print substrates of the type observed in the prior art.

The desired printing ink concentration can be achieved in a scrambling pattern layer, even on essentially absorbent paper, by means of a barrier layer, which is impermeable to the printing ink, at least in the percentage proportion referred to. The barrier layer may, for example, be made from a material customarily used for the coating of so-called base coating paper. These coatings, which can be painted on, for example, are also used to obtain the closest and also smoothest surface possible and consist of, for example, China clay, chalk, casein or a plastic dispersion. Despite their density and smoothness, they still display good anchoring properties for printing ink.

When using a special, chemically decolourable printing ink, the concentration of printing ink has the additional advantage of being reached more quickly by the decolouring agent. This means that decolouration also takes place more quickly, possibly taking only a few seconds. Moreover, it is significantly more effective and comprehensive.

The printing ink used to print the scrambling pattern should preferably have a matt appearance, to prevent any information sequence printed on top of it from being identified by its glossiness. It is especially advantageous for the printing ink to be matched, both in terms of its shade and glossiness, to customary toners, such as those used by laser printers.

In accordance with the fourth solution feature in the invention, the scrambling pattern can be removed at least partly and/or along with other layers using an adhesive strip with a peeling force of between 0.5 N/50 mm and 2 N/50 mm according to Finat test method no. 1 (for Finat test method no. 1, see also www.finat.com). The peeling force is preferably around 1 N/50 mm.

As experience of known print substrates of the type considered has already revealed, it may be entirely possible to remove the printing ink or toner used to print the confidential information sequence from the scrambling pattern at least in part using an adhesive strip, so that the sequence on the adhesive strip is identifiable. Through the aforementioned design, this sort of attempted tampering would cause the scrambling pattern to be removed at least partly and/or along with other layers of the print substrate, whereby the print substrate would be destroyed and the tampering made evident. The aforementioned design would of course be redundant if it were possible to anchor the ink used to print the confidential information sequence to the scrambling pattern sufficiently strongly.

In order to achieve the values specified, the scrambling pattern printing or scrambling pattern layer may be disposed on an intermediate layer, which, when exposed to a corresponding stress, suffers an internal cohesion break or an adhesion break to an adjacent interface. The aforementioned barrier layer may be used as the intermediate layer, possibly combined with a dividing layer.

In accordance with the fifth solution feature in the invention, the print substrate is provided with a thermochromatic reagent, which changes colour irreversibly under the effects of heat from a temperature of 140°. Suitable reagents are state-of-the-art and commercially available.

This feature takes account of the fact that with the known print substrates of the type considered, it is possible to read the confidential information with the aid of an iron, insofar as this is printed using laser printer toner. All that is required is for a thin sheet of smooth paper to be placed over the printing and ironed until a legible imprint appears on the paper. The imprint is produced due to the fact that toner is thermoplastic and starts to soften again at a given temperature. The feature in the invention means that the reagent would change colour if an attempt was made to tamper with it in this way, thereby making it tamper-evident. The specified threshold temperature of 140° C. for the reagent used is arrived at due to the fact that it should not yet change colour at the customary fixing temperature for laser printer toner.

According to a preferred embodiment of the invention, the thermochromatic reagent is disposed on the back of a carrier layer with the scrambling pattern on the front and is therefore unable to affect the printing of the scrambling pattern and the possibly special and preferably chemically decolourable printing ink used for this.

In accordance with the sixth solution feature in the invention, the print substrate is alternatively or additionally provided with a solvent-reactive reagent, which changes colour irreversibly in a solvent atmosphere. Suitable reagents are state-of-the-art and commercially available.

This feature takes account of the fact that certain printing inks, for instance the chemically decolourable printing ink preferably used for the scrambling pattern, decolour reversibly in cold solvent vapour, e.g. acetone vapour, so that the confidential information is temporarily visible.

The irreversible change in colour of the reagent used would also make this sort of attempted tampering evident later.

Like the thermochromatic reagent, the solvent-reactive reagent can also be disposed on the back of a carrier layer with the scrambling pattern printed on the front.

Within the framework of the embodiments in which the scrambling pattern is printed using a special printing ink, which can be decoloured using a chemical decolouring agent, it is advantageous for the decolouring agent to be stored right on the print substrate and/or even incorporated in its structure.

### BRIEF DESCRIPTION OF THE FIGURES

With reference to the drawings, exemplary embodiments of the invention will now be explained. In the figures:

FIG. 1 shows a highly magnified photograph of a scrambling pattern printed with a confidential information sequence according to the invention;

FIG. 2 shows a similarly magnified photograph of the confidential information sequence from FIG. 1 against a uniformly light background in the form of the FIG. 2;

FIG. 3 shows a basic embodiment of a print substrate according to the invention;

FIG. 4 shows an embodiment of a print substrate according to the invention with a two-layer scrambling pattern;

FIG. 5 shows an embodiment of a print substrate according to the invention with a barrier layer adjacent to the scrambling pattern layer;

FIG. 6 shows an embodiment of FIG. 5 with the barrier layer torn off;

FIG. 7 shows an embodiment of a print substrate according to the invention with a barrier layer and an adjacent separating layer;

FIG. 8 shows an embodiment of a print substrate according to the invention with a coating that changes colour irreversibly under the effects of heat and/or in a solvent atmosphere;

FIG. 9 shows a further embodiment of a print substrate according to the invention with a coating that changes colour irreversibly under the effects of heat and/or in a solvent atmosphere;

FIG. 10 shows yet a further embodiment of a print substrate according to the invention with a coating that changes colour irreversibly under the effects of heat and/or in a solvent atmosphere;

FIG. 11 shows a print substrate in accordance with FIG. 5, which has an additional protective layer on top and an additional pressure-sensitive adhesive layer on the back and a sealing layer for the adhesive layer;

FIG. 12 shows an embodiment of a print substrate with an integrated decolouring agent, a pressure-sensitive adhesive layer on the back and a sealing layer for this adhesive layer;

FIG. 13 shows the print substrate in accordance with FIG. 12 following removal of the sealing layer adhered to a substrate and provided with a printed information sequence;

FIG. 14 shows the print substrate from FIG. 13 following the removal of an upper integrated arrangement with the information sequence;

FIG. 15 shows the print substrate from FIG. 13 after the integrated arrangement shown removed in FIG. 14 has been turned over and adhered back onto the remaining lower arrangement with the integrated decolouring agent;

FIG. 16 shows under a) a plan view of a print substrate in the form of a substrate according to the invention with a removable scrambling pattern part and a reactive label in the original state;

FIG. 17 shows the substrate from FIG. 16 with the scrambling field part removed and inserted beneath the reactive label;

FIG. 18 shows the substrate from FIG. 17 following the decolouration of the scrambling field and exposure of a confidential information sequence printed on the scrambling pattern;

FIG. 19 shows a section (A-A) through the substrate in FIG. 16;

FIG. 20 shows a section (B-B) through the substrate in FIG. 17 and

FIG. 21 shows an embodiment corresponding to that in FIG. 19 with further layers added.

### METHODS OF IMPLEMENTING THE INVENTION

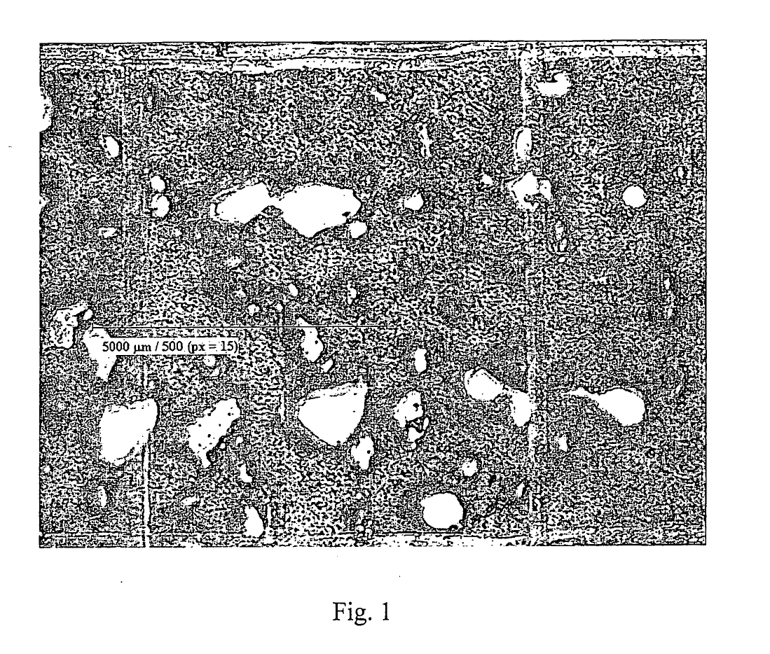

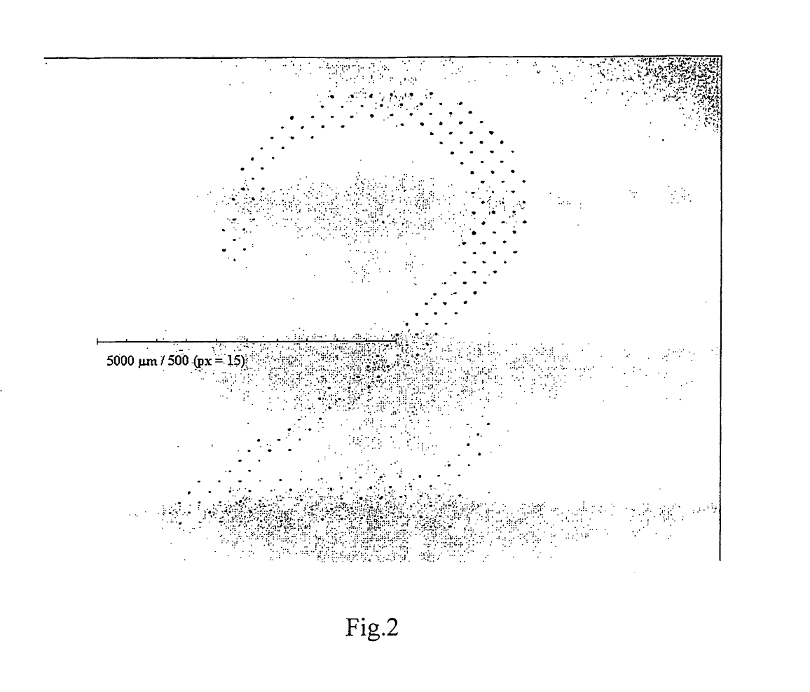

The photograph in FIG. 1 shows a small, but highly magnified section of a scrambling pattern according to the invention in the form of a sea of figures on which the FIG. 2 is printed against a uniformly light background and broken down into individual raster dots spaced apart from one another. However, the FIG. 2 cannot be made out in FIG. 1 due to the scrambling. The multiplicity of small ink dots of various sizes randomly distributed over the scrambling pattern in FIG. 1 make an essential contribution to the effective scrambling.

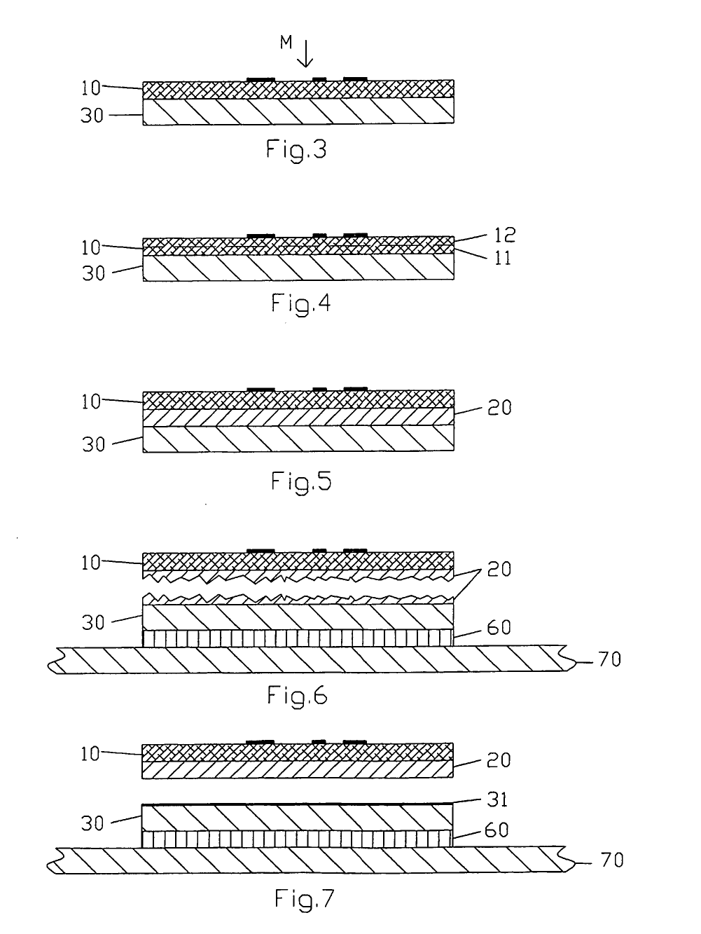

In a basic design, the print substrate, as shown in section in FIG. 3, may simply have a carrier layer 30 with a scrambling pattern 10 printed on one side using a printing ink that can be bleached using a chemical decolouring agent and mixed with particles of the type described earlier.

FIG. 3 also shows in diagrammatic form a confidential information sequence M printed straight onto the scrambling pattern, e.g. using laser printer toner. This can be identified by bleaching the printing ink used in the scrambling pattern. The carrier layer 30 may be, for example, paper or a layer of film. In FIG. 3 the individual layers are depicted with an exaggerated thickness, which also applies to all other sectional representations.

FIG. 4 shows an embodiment of a print substrate in which the scrambling pattern 10 is made up of two superimposed printed layers 11 and 12. Layer 11 was dried prior to the application of layer 12.

In the embodiment in FIG. 5, the carrier layer 30 is made from absorbent paper, for example. However, a barrier layer 20 prevents the printing ink from the scrambling pattern layer from penetrating the carrier layer during printing. The printing ink therefore remains concentrated mainly in the scrambling pattern layer, where it produces a print-intensive image and can also be reached quickly and easily by the chemical decolouring agent required for its decolouration.

At least one of the layers of the print substrate according to the invention is advantageously designed so that it only has a low internal coherence and suffers a break in cohesion if attempts are made to remove the confidential information sequence, e.g. by means of an adhesive strip. This sort of break in cohesion is shown in FIG. 6 using the example of the barrier layer 20, which is torn into two pieces. Rather than a break in cohesion, a break in adhesion, e.g. to a separating layer 31, as shown in FIG. 7, would perform the same function.

FIGS. 6 and 7 also depict the print substrate according to the type of self-adhesive label. It is provided with a pressure-sensitive adhesive layer 60 on the back of the carrier layer 30 and is adhered with the help of this to a larger substrate 70. The substrate 70 may, in particular, be a conventional sheet of paper, e.g. A4 size.

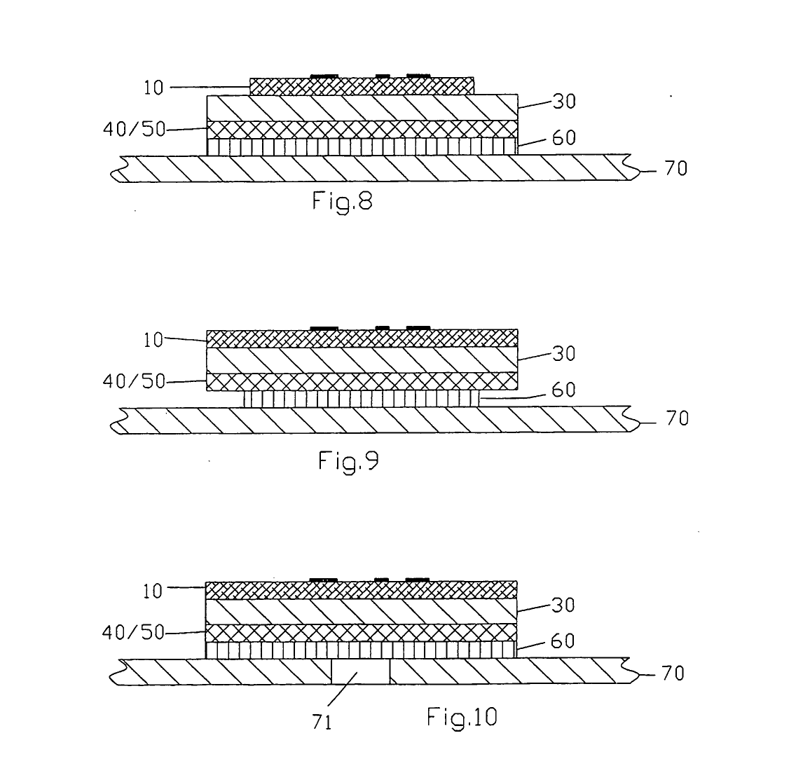

FIGS. 8-10 show a print substrate of a similar design on a substrate 70, wherein an additional coating 40 or 50 is provided on the back of the substrate layer 30. Coating 40 is a thermochromatic reagent, which changes colour irreversibly from a temperature of about 140° C. Coating 50 is a solvent-reactive reagent, which changes colour irreversibly in a solvent atmosphere, e.g. acetone vapour. The change in colour reveals any attempts to expose the confidential information by ironing partially on another carrier or to make it temporarily visible by reversible decolouration of the printing ink. Alternatively, the two reagents may be present alongside one another or mixed together. A reagent displaying both properties simultaneously could also be used.

To ensure that the change in colour of the coating 40/50 is clearly visible, despite the scrambling pattern 10, the scrambling pattern layer 10 is slightly smaller in size than the coating 40/50 in the embodiment in FIG. 8. In this case, the substrate layer should also be transparent. In FIG. 9, the pressure-sensitive adhesive layer 60 is also slightly smaller in size than the carrier layer for the same reason, which means that its edge strips can be lifted giving a direct view of the coating 40/50. In FIG. 10, a die-cut has been made in the substrate 70 beneath the print substrate, giving a view of part of the coating 40/50.

The existence of the intermediate layer 20 means that the printing ink used to print the scrambling pattern is virtually unable to be absorbed down, as was explained earlier for normal paper. This means, in particular, that the more volatile components of the printing ink with a higher boiling point remain in the scrambling pattern layer, which may possibly affect the smudge and scratch-resistance of this layer. This may lead to undesirable effects during further processing, e.g. “ghosting”. Ghosting is a technical term for printing in which there is no printing form and the impression of the actual printing produces more than one image, due to inadequate abrasion resistance; this image becomes increasingly faint and is extremely inconvenient.

In order to achieve adequate smudge and scratch-resistance, the following steps can be taken either individually or together:
The print substrate can be actively dried immediately after the printing ink has been applied, whereby in particular those components of the printing ink used with a higher boiling point can be effectively removed. Particularly effective and intensive drying is achieved using, e.g. high-speed, hot air. This may involve the use of so-called floating web driers if the special printing ink is continuously applied to a continuous print substrate web; these create a cushion of high-speed, hot air from both sides of the web and keep the web suspended without the need for rollers.
The printing ink is formulated using organic solvents with the lowest possible boiling point or water or a reactive dye is used in addition, as in a dual-component system, for example, with a resin and hardener. A 100% solid formulation may also be chosen as the curing system with or without photo-initiators (UV or EB curing).
The surface of the scrambling pattern 120 is provided with a transparent protective layer 110, which increases the abrasion and scratch-resistance of the printing ink, as shown in FIG. 11. Layers 130, 140 and 150 correspond to layers 20, 30 and 60 in FIG. 6 or 7 in the aforementioned sequence. Layer 190 is a sealing paper, e.g. in the form of silicon paper. In the event that the printing ink should be chemically decolourable using a decolouring agent, the protective layer 110 must naturally be sufficiently permeable to the decolouring agent. This can be achieved, e.g. by means of a porous or latticed structure in the protective layer 110. Furthermore, this layer should only be very thin, measuring between 1-2 μm, for instance.

FIG. 12 shows an embodiment of a print substrate in accordance with the invention with an integrated decolouring agent. The top four layers 110-140 correspond to those in FIG. 11. Moreover, in this case layers 130 and 140 are transparent. The carrier layer 140 may be a plastic film, for example, in particular a preferably slightly matt, stretched polyester film roughly 50 μm thick.

Beneath the carrier layer 140 there is a further carrier layer 170 in the embodiment in FIG. 12 and between the two carrier layers 140 and 170 are two outer, preferably strip-shaped, pressure-sensitive adhesive layers 151 and 152, between which is inserted a likewise preferably strip-shaped layer 160, which encapsulates the decolouring agent e.g. in liquid form in microcapsules that can be destroyed under pressure. The other carrier layer 170 is preferably a very thin film layer measuring around 12 μm.

The decolouring agent is tightly embedded between the two carrier layers 140 and 170 and the two pressure-sensitive adhesive layers 151 and 152, particularly when the carrier layers 140 and 170 are film layers, which is preferable. This means that any loss of decolouring agent with time, due to evaporation, for instance, is virtually impossible.

On the back of the additional carrier layer 170 is another pressure-sensitive adhesive layer 180, which is in turn provided with a detachable sealing layer 190. In this case, the sealing layer 190 is the same size as the other print substrate layers.

The print substrate in FIG. 12 could (as with all the other print substrates described) also be a continuous strip-shaped material with a uniform structure running at right angles to the plane of the paper, from which individual print substrates could be obtained by cutting off lengths, which could then be applied on a web finishing line to a continuous paper web or to continuous individual sheets or forms. This sort of continuous material could also be used to make label material by die-cutting a lattice shape. The continuous materials in each case can be rolled up thanks to the sealing layers 190 and are preferably also produced on rolls and further processed.

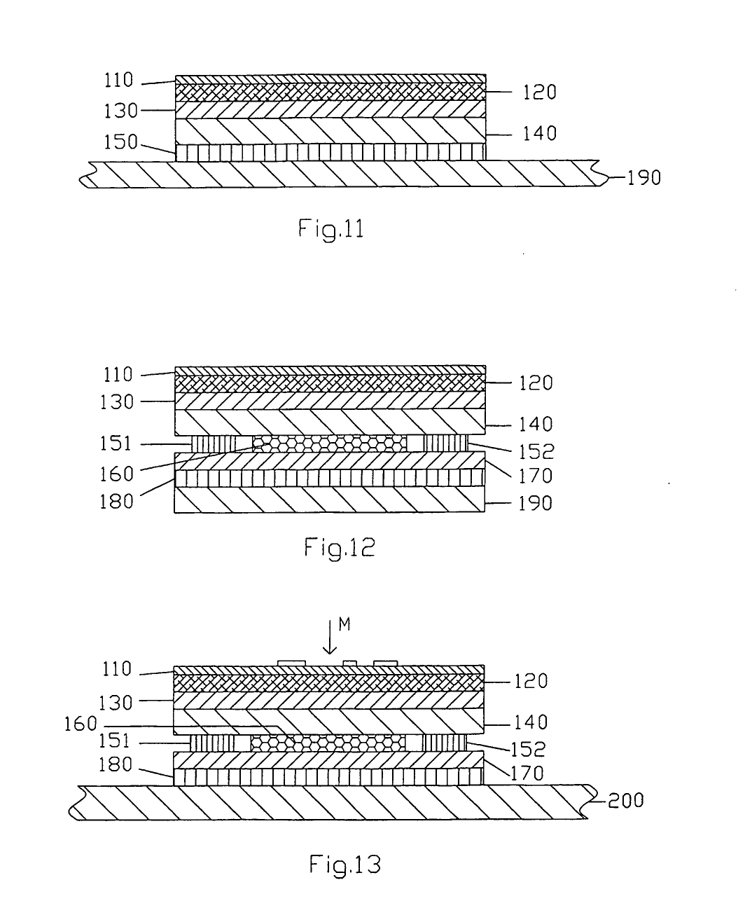

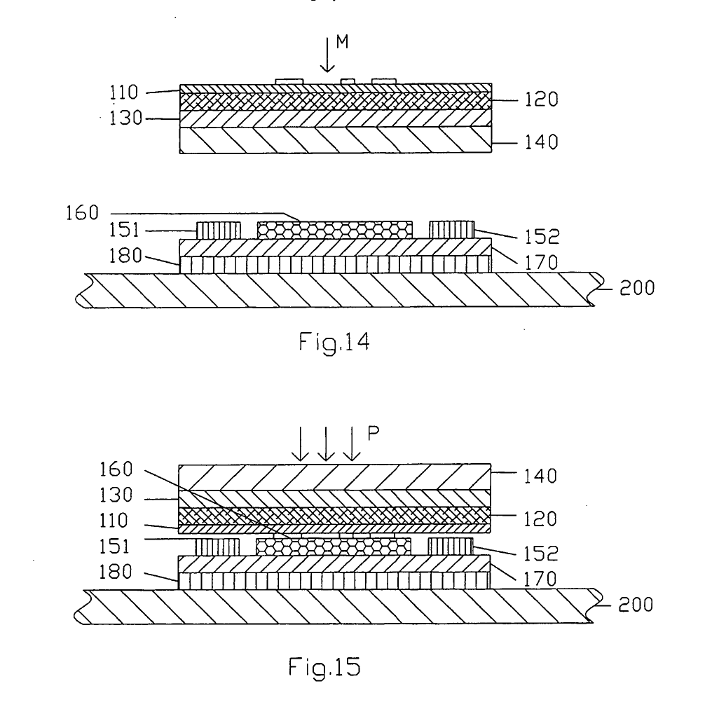

FIGS. 13-15 will now be used to explain how the print substrate in FIG. 12 is handled.

FIG. 13 shows the print substrate from FIG. 12, following removal of the sealing layer 190, adhered to a substrate in the form of a sheet of paper 200, wherein a confidential information sequence M (inverted) has already been printed on the top.

In FIG. 14, an upper integrated arrangement of the print substrate with the information sequence M and layers 110-140 is removed from the other layers 151, 151 [sic] and also 160-180 and in FIG. 15 is stuck back onto these layers after being turned round. In this way, the scrambling pattern layer 120 has come into contact with the layer 160 containing the decolouring agent, at least directly through the permeable protective layer 110.

In order to decolour the special printing ink in the scrambling pattern layer, all that is needed is for a certain pressure (arrow P) to be applied over the entire integrated arrangement, e.g. by rubbing a finger over it, thereby releasing the decolouring agent contained in the layer 160 in capsule form. Since by far the greatest proportion of special, decolourable printing ink is concentrated in the adjacent scrambling pattern layer 120, decolouration takes place quickly and effectively once the decolouring agent has been released. The confidential information sequence M can be distinguished through the transparent layers 140 and 130 at a corresponding speed and with a good degree of contrast. Moreover, an exceptionally small amount of decolouring agent is sufficient, e.g. only 10-20 g/m².

Removal of the upper integrated arrangement containing layers 110-140, as shown in FIG. 14, is facilitated by the fact that the two pressure-sensitive adhesive strips 151 and 152 are each disposed a little way from the edge of the arrangement to be removed, producing narrow tabs on either side, by which the arrangement can easily be gripped for removal. The adhesive properties of the pressure-sensitive adhesive on the strips 151 and 152 on the underside of the carrier layer 140 naturally also play a part in removal. This bond must be capable of being broken. This requirement is met when using a polyester film for the carrier layer 140.

The fact that the pressure-sensitive adhesive layers 151 and 152 and also the layer 160 with the decolouring agent are strip-shaped is beneficial to their production. It means that they can be economically produced using the continuous method by coating a continuous web (carrier layer 170).

Insofar as the print substrate from FIG. 12 is intended to be adhered to a plastic substrate rather than a sheet of paper, for example, the two layers 170 and 180 could also be omitted if necessary, because then the layer 160 containing the decolouring agent would already be protected against evaporation of the decolouring agent by the plastic substrate.

Yet a further embodiment is described below, in which a decolouring agent is stored for use on the print substrate.

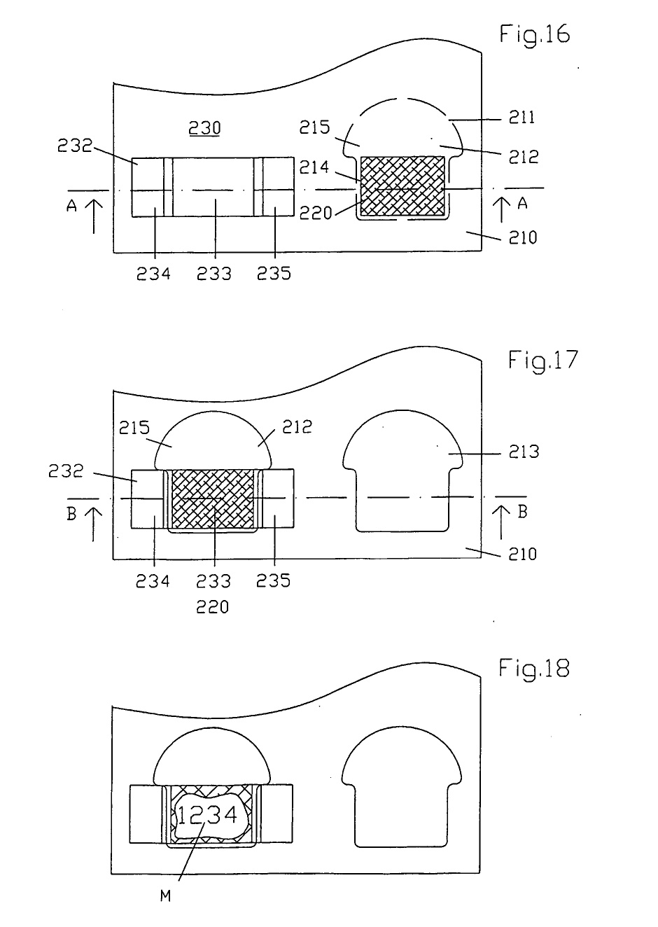

The print substrate only partly illustrated in FIGS. 16-18 in the form of a substrate 210 is, for example, a sheet of A4-size paper, as can be processed particularly by conventional laser or inkjet printers.

According to FIG. 16, the substrate 210 is provided with a scrambling pattern 220 and also with a reactive label 230.

The scrambling pattern layer 222 of the scrambling pattern 220 is printed using a special printing ink, which, unlike standard printing ink, can be irreversibly bleached using a chemical decolouring agent.

The scrambling pattern 220 is disposed on part 212 of the substrate 210, which is delimited from the remaining substrate 210 by a perforation 211. The perforation 211 may be a web or micro-perforation die-cut. By separating the perforation 211, the part 212 can be removed from the integrated arrangement with the remaining substrate 210. The part 212 comprises a first section 214, which essentially corresponds to the scrambling pattern 220, and a second, slightly wider section 15, which can be used as a tab. The edges of the part 212 are rounded, to prevent unwanted cracking when the part 212 is removed.

The reactive label 230 comprises a transparent carrier layer 232 made from polyester, for example, which has on its underside, i.e. the side facing the substrate 210, a layer 233 containing a liquid decolouring agent for bleaching the special printing ink used in the scrambling pattern layer 222, e.g. in microcapsule form. The carrier layer 232 is secured to the substrate 210 on both sides of the layer 233 by two strip-shaped adhesive layers 234 and 235. The layer 233 itself, however, is not connected to the substrate 210. The adhesive on the adhesive layers 234 and 235 is selected and/or set up so that the carrier layer 232 cannot be detached from the substrate 210 without being destroyed.

So that a confidential information sequence M printed on the scrambling pattern 220 in FIG. 1, which is unrecognisable against the background of the scrambling pattern, can be distinguished, the part 212 containing the scrambling pattern 220 is removed from the integrated arrangement with the remaining substrate 210 and then inserted under the carrier layer 232 of the reactive label 230, so that the scrambling pattern 220 or the scrambling pattern layer 222 is directly covered by the layer 233 containing the decolouring agent. A relatively large hole 213 is left at the point on the substrate 210 from which the part 12 was detached.

FIG. 17 shows the substrate from FIG. 16 with the part 212 detached and then section 214 of the part inserted between the carrier layer 232 of the reactive label 230 and the substrate 210. This insertion is possible because the layer 233, as already mentioned, is not connected to the substrate 210. Moreover, the distance between the two pressure-sensitive adhesive layers 234 and 235 is slightly greater than the width of the section 214. This means that section 214 of part 212 can be easily and conveniently inserted between the carrier layer 232 and the substrate 210, because the part 212 can be gripped by section 215 in the manner of a tab. Because section 215 is slightly wider than section 214, it is further advantageous for there to be a stop at the top of the two pressure-sensitive adhesive layers 234 and 235 to ensure that the scrambling pattern 220 precisely covers the layer 233.

In order to distinguish the information sequence M printed on the scrambling pattern 220, all that is then required is for pressure to be applied to the carrier layer 232, in order to destroy the microcapsules and release the decolouring agent contained in them to bleach the special printing ink used in the scrambling pattern layer 222. FIG. 18 shows the situation after the scrambling pattern has been bleached with an information sequence M distinguishable in the bleached section.

It is preferable for a very thin film with a thickness of only about 36 μm to be used for the carrier layer 232. In this case, a comparatively small amount of pressure on the film's surface is sufficient to release the decolouring agent. The use of such a thin film is possible because it no longer needs to be freely handled once it has been adhered to the substrate 10.

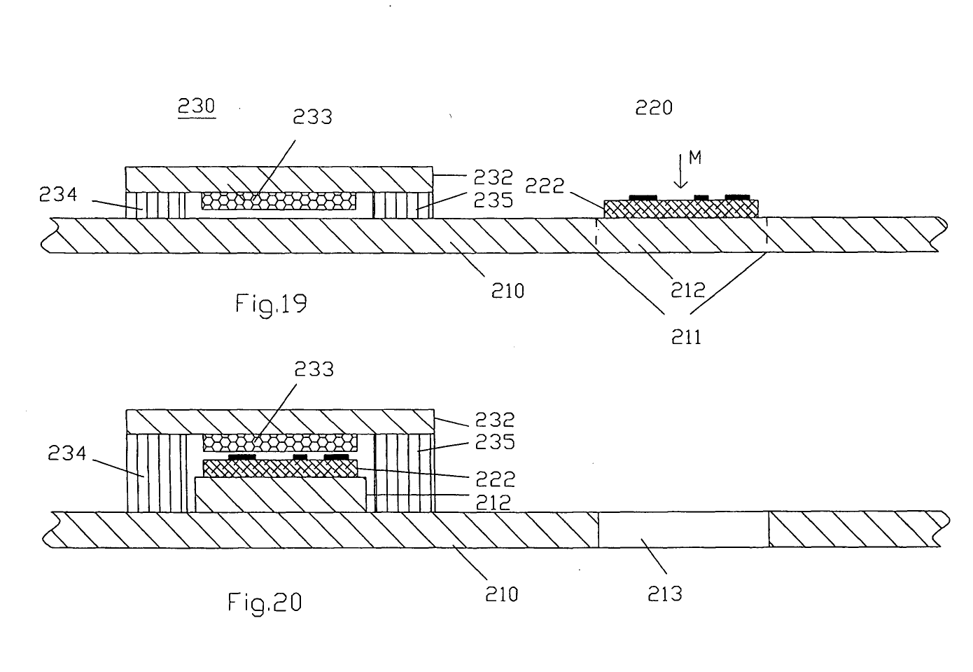

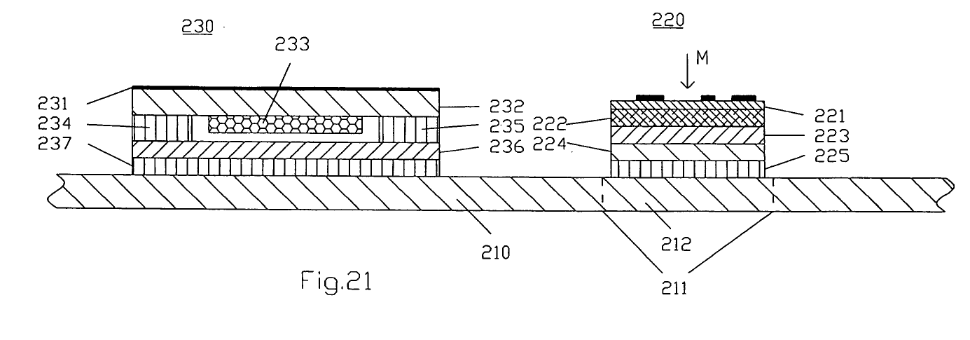

FIG. 19 illustrates the layer composition of the substrate from FIG. 16 through a section A-A, as described above. The confidential information sequence M, which could not be distinguished in the plan view in FIG. 16, is printed on the surface of the scrambling pattern layer 222.

FIG. 20 shows the layer construction of the substrate in accordance with FIG. 17 along a section B-B, i.e. as it is following the removal of part 212 with the scrambling pattern 220 from the integrated arrangement with the remaining substrate 210 and the subsequent insertion of the part 212 beneath the carrier layer 232 of the reactive label 230.

Finally, FIG. 21 shows in a representation corresponding to that in FIG. 19 a preferred embodiment of a substrate according to the invention, in which both the scrambling pattern 220 and the reactive label 230 have further layers added to them, which make it possible, among other things, for the two units to be prefabricated all in one and applied to the substrate 210 as applicator parts, e.g. using a label applicator. This, along with the addition of the perforation 211, can be undertaken particularly economically in a continuous process in which the substrate 210 forms a continuous web, which is only later divided into individual sheets, for example.

In the embodiment in FIG. 21 the design of the scrambling pattern 220 comprises, in addition to the scrambling pattern layer 222 already mentioned, a further transparent protective layer 221 on this and beneath it an intermediate layer 223, a carrier layer 224 and a pressure-sensitive adhesive layer 225. The pressure-sensitive adhesive layer 225 should preferably be set up so that the entire scrambling pattern structure cannot be removed from the substrate 210 without being destroyed.

The carrier layer 224 may be a paper or also a film layer, particularly with a thickness of approx. 60 μm in the latter case. It must facilitate the coherence of the entire scrambling pattern construction and enable it to be “handled” during application.

The scrambling pattern layer is anchored to the carrier layer 224 by the intermediate layer 223 without the printing ink from the scrambling pattern layer 222 being able to penetrate to any great degree the intermediate layer 223 or even the carrier layer 24 below it. At least 50% but preferably over 90% of the printing ink used is concentrated in the scrambling pattern layer 22.

The protective layer 210 is used to avoid the ghosting phenomenon already described earlier and achieve adequate smudge and scratch-resistance in the scrambling pattern 222. To ensure it is sufficiently permeable to the decolouring agent, it is designed as a porous or latticed structure with a thickness of only 1-2 μm.

In addition to the layers 232-235 already mentioned, the reactive label 230 in accordance with FIG. 21 also comprises on the top of the carrier layer 232 a transparent slip layer 231 and also a further carrier layer 236 beneath the adhesive layers 234 and 235, as well as a pressure-sensitive adhesive layer 237. The latter forms the connection between the reactive label and the substrate 210 and is once again designed such that the entire structure of the reactive label 230 cannot be detached from the substrate 210 without being destroyed. The additional carrier layer 236 is preferably a film layer, like the carrier layer 232, e.g. made from polyester and is likewise preferably only very thin, e.g. 12 μm thick.

The slip layer 231 advantageously reduces the noticeable slip resistance of the carrier layer 232 surface, e.g. when rubbing a finger over it to reveal a piece of confidential information, so that rubbing is made easier. The slip resistance is preferably reduced by the slip layer 231 to such an extent that the peeling force necessary to move a 5×7 cm² piece of carrier layer coated with the slip layer on a uniformly horizontal surface during the application of a weight load of 416 g at a constant speed of 138.8 cm/min, is below 1 N and preferably only around 0.5 N.

Readymade films that already have a suitable slip layer are commercially available, e.g. under the trade name LUMIRROR 50.12 from the company Toray Plastics S.A., St Maurice de Beynost, F-01708 Miribel Cedex. Alternatively, the slip layer 41 may also be produced using a protective lacquer formulation, such as those supplied by various paint and lacquer manufacturers. With these, the slip value is set by adding special sliding waxes, for example for lacquers as a basic aqueous dispersion with LUBA-print wax dispersion 138, available from L P Bader & Co GmbH, PO Box 1137, D-7861 Rottweil.

The decolouring agent in layer 233 is tightly embedded between the two carrier layers 232 and 236 and the two pressure-sensitive adhesive layers 234 and 235, particularly when both carrier layers are film layers, which is certainly preferable. A loss of decolouring agent with time, due to evaporation, for instance, is therefore virtually impossible.

Apart from the decolouring agent in microcapsule form, the layer 233 should preferably also include a binding agent, which contains a wood adhesive and/or an odorising agent and/or a liquid-absorbing agent and/or a dye.

Finally, is should be mentioned that individual solution or also design features of the invention, insofar as they only occur and were explained above in the context of individual or special exemplary embodiments, could also be used with other exemplary embodiments and together in different combinations. All features described may be used, particularly with embodiments of the type shown in FIG. 21, wherein multilayer integrated arrangements are prefabricated all in one with the scrambling pattern, on the one hand, and/or a decolouring agent, on the other, and only need to be applied to a form, for instance.

### REFERENCE LIST

10 Scrambling pattern or scrambling pattern layer
11 Scrambling pattern sublayer
12 Scrambling pattern sublayer
20 Barrier layer
30 Carrier layer
31 Dividing layer
40 Thermochromatic reagent coating
50 Solvent-reactive reagent coating
60 Pressure-sensitive adhesive layer
70 Substrate/sheet of paper
71 Die-cut
110 Protective layer
120 Scrambling pattern layer
130 Intermediate layer
140 Carrier layer
150 Pressure-sensitive adhesive layer
151, 152 Pressure-sensitive adhesive layers
160 Layer containing decolouring agent
170 Additional carrier layer
180 Pressure-sensitive adhesive layer
190 Sealing layer
200 Substrate, sheet of paper
210 Substrate
211 Perforation die-cut
212 Detachable part of the substrate
213 Hole
214 Section of 12
215 Section of 12
220 Scrambling pattern
221 Protective layer
222 Scrambling pattern layer
223 Intermediate layer
224 Carrier layer
225 Adhesive layer
230 Reactive label
231 Slip layer
232 Carrier layer
233 Layer containing decolouring agent
234 Adhesive layer
235 Adhesive layer
236 Additional carrier layer
237 Pressure-sensitive adhesive layer
M Confidential information sequence
P Arrows indicating pressure

1. A print substrate with a scrambling pattern on which an information sequence can be printed in such a manner that it can only be distinguished against the background of the scrambling pattern once certain actions have been performed, characterised by at least one of the following features:
the scrambling pattern contains randomly distributed ink dots within the range 50-400 μm with a total surface area of between 0.3-0.5 cm² per cm²; and/or
the scrambling pattern is made up of a plurality of superimposed printed layers; and/or
the scrambling pattern is printed using a printing ink, at least 50% of which is concentrated in a scrambling pattern layer; and/or
the scrambling pattern can be removed at least partly and/or along with other layers using an adhesive strip with a peeling force of between 0.5 N/50 mm and 2 N/50 mm according to Finat test method no. 1; and/or
the print substrate is provided with a thermochromatic reagent, which changes colour irreversibly under the effects of heat from a temperature of 140°; and/or
the print substrate provided with a solvent-reactive reagent, which changes colour irreversibly in a solvent atmosphere.

2. The print substrate according to claim 1, wherein the scrambling pattern contains randomly distributed ink dots within the range 20-400 μm with a total surface area of between 0.3-0.5 cm² per cm², characterised in that the scrambling pattern is printed using a liquid printing ink and the ink dots are formed by particles added to the printing ink.

3. The print substrate according to claim 2, characterised in that the number of ink dots is in the region of 50-100 μm 2000-5000 per cm², in the region of 100-200 μm 500-1000 per cm² and in the region of 200-400 μm 200-500 per cm².

4. The print substrate according to claim 2 or 3, characterised in that the particles added to the printing ink are preferably porous and have through the absorption of printing ink taken on a colour roughly matching this.

5. The print substrate according to claim 4, characterised in that the particles added to the printing ink consist of amorphous silicic acid.

6. The print substrate according to one of the claims 2-5, characterised in that the particles added to the printing ink have a grain size of 5-7 μm and that the ink dots are produced through the agglomeration of these particles.

7. The print substrate according to one of the claims 1-6 and in which the scrambling pattern is printed using a printing ink of which at least 50% is concentrated in a scrambling pattern layer, characterised in that at least 90% of the printing ink is concentrated in the scrambling pattern layer.

8. The print substrate according to one of the claims 1-7 and in which the scrambling pattern is printed using a printing ink of which at least 50% is concentrated in a scrambling pattern layer, characterised in that it has a barrier layer adjacent to the scrambling pattern layer, which is impermeable to the printing ink, at least in the percentage proportion referred to.

9. The print substrate according to one of the claims 1-8 and in which the scrambling pattern can be removed at least partly or along with other layers using an adhesive strip with a peeling force of between 0.5 N/50 mm and 2 N/50 mm according to Finat test method no. 1, characterised in that the scrambling pattern can be removed with a peeling force of about 1 N/50 mm.

10. The print substrate according to one of the claims 1-9 and which is provided with a thermochromatic reagent, which changes colour irreversibly under the effects of heat from a temperature of 140°, characterised in that the thermochromatic reagent is disposed on the back of a carrier layer with the scrambling pattern on the front.

11. The print substrate according to one of the claims 1-10 and which is provided with a solvent-reactive reagent, which changes colour irreversibly in a solvent atmosphere, characterised in that the solvent-reactive reagent is disposed on the back of a carrier layer with the scrambling pattern printed on the front.

12. The print substrate according to one of the claims 1-11, characterised in that it is in the form of a self-adhesive label and is provided with a pressure-sensitive adhesive layer on the back, possibly in strip form.

13. The print substrate according to one of the claims 1-12, characterised in that the scrambling pattern is produced using a special printing ink, which unlike standard printing ink, such as laser printer toner or inkjet printing ink, in particular, can be irreversibly bleached using a chemical decolouring agent.

14. The print substrate according to claim 13, characterised in that the scrambling pattern surface is provided with a protective layer that increases the abrasion and scratch-resistance of the special printing ink but is permeable to a decolouring agent.

15. The print substrate according to one of the claims 13 or 14, characterised in that it is provided with a decolouring agent, preferably in strip form, on the back of a first carrier layer, the front of which at least directly bears the scrambling pattern layer.

16. The print substrate according to claim 15, characterised in that the decolouring agent is embedded between the first carrier layer, the front of which at least directly bears the scrambling pattern layer, and a second carrier layer.

17. The print substrate according to claim 16, characterised in that the second carrier layer is a plastic film.

18. The print substrate according to one of the claims 16 or 17, characterised in that the second carrier layer is provided with a pressure-sensitive adhesive layer on the back.

19. The print substrate according to one of the claims 12 or 18, characterised in that the pressure-sensitive adhesive layer is provided with a removable sealing layer, preferably a continuous layer.

20. The print substrate according to claim 12, characterised in that a reactive label with a transparent carrier layer is attached to it and cannot be detached without being destroyed, which has on its surface facing the print substrate a chemical decolouring agent for the irreversible bleaching of the special printing ink, and that part of the print substrate with the scrambling pattern can be removed from the integrated arrangement with the remaining print substrate and can then be inserted beneath the carrier layer of the reactive label, so that the scrambling pattern is directly covered by the decolouring agent.

21. The print substrate according to claim 20, characterised in that the part of the print substrate with the scrambling pattern is connected to the remaining print substrate by a perforation, particularly in the form of a web or micro-perforation die-cut.

22. The print substrate according to claim 20 or 21, characterised in that the part of the print substrate with the scrambling pattern that can be removed from the integrated arrangement with the remaining print substrate has a first section essentially corresponding to the scrambling pattern and a second section acting as a tab.

23. The print substrate according to one of the claims 20-22, characterised in that the decolouring agent is embedded in binding agent, which contains wood adhesive and/or an odorising agent and/or a liquid-absorbing agent and/or a dye.
